(19) United States
(12) Patent Application Publication
(10) Pub. No.: US 2022/0366272 A1
(43) Pub. Date: Nov. 17, 2022

(54) LEARNING DEVICE, PREDICTION DEVICE, LEARNING METHOD, PREDICTION METHOD, LEARNING PROGRAM, AND PREDICTION PROGRAM

(71) Applicant: NIPPON TELEGRAPH AND TELEPHONE CORPORATION, Tokyo (JP)

(72) Inventors: Daisuke SATO, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/621,232

(22) PCT Filed: Jun. 26, 2019
(86) PCT No.: PCT/JP2019/025474

§ 371 Date: Dec. 20, 2021

(51) Int. Cl. G06N 5/02

(52) U.S. Cl. CPC G06N 5/022; G06Q 10/04

(57) ABSTRACT

A learning device includes: an extraction unit configured to extract event components, each of the event components representing a degree of variations between spatio-temporal observation data in a normal time and the spatio-temporal observation data during variations, the spatio-temporal observation data being spatio-temporal observation data with an attribute observed in advance and including an observation value as an element of an observation time and an observation location; a classification unit configured to classify the event components into events given in advance, based on the observation time, the observation location, the attribute, and the event component; and a learning unit configured to learn a model for predicting variations in the spatio-temporal observation data for each of the events, based on a classification result for the event.

### TECHNICAL FIELD

The disclosed techniques relate to a learning device, a prediction device, a learning method, a prediction method, a learning program, and a prediction program.

### BACKGROUND ART

A number of techniques for predicting spatio-temporal observation data have been proposed. Among these, the conventional technique described in PTL 1 can predict spatio-temporal observation data, including sudden variations different from a normal time, such as a sudden gathering of people in an event site, for example.

### CITATION LIST

### Patent Literature

PTL 1: JP 2018-22237 A

### SUMMARY OF THE INVENTION

### Technical Problem

Because the technique described in PTL 1 treats spatio-temporal observation data as an input without distinguishing variations in spatio-temporal observation data, there is a possibility that incorrect correlations may be learned. Preventing this is important for accuracy improvement. For example, there may be two large event sites in an area, and there may be completely no relationship between the participant behaviors of respective events. This technique may capture an increase/decrease correlation of variations of participants related to the two events without considering the events, and the accuracy reduction of the prediction can be problematic.

An object of the present disclosure is to provide a learning device, a prediction device, a learning method, a prediction method, a learning program, and a prediction program that enable prediction of spatio-temporal observation data in consideration of variations for each event and that can improve overall prediction accuracy.

### Means for Solving the Problem

A first aspect of the present disclosure is a learning device including: an extraction unit configured to extract event components, each of the event components representing a degree of variations between spatio-temporal observation data in a normal time and the spatio-temporal observation data during variations, the spatio-temporal observation data being spatio-temporal observation data with an attribute observed in advance and including an observation value as an element of an observation time and an observation location; a classification unit configured to classify the event components into events given in advance, based on the observation time, the observation location, the attribute, and the event component; and a learning unit configured to learn a model for predicting variations in the spatio-temporal observation data for each of the events, based on a classification result for the event.

A second aspect of the present disclosure is a prediction device including: an extraction unit configured to extract event components, each of the event components representing a degree of variations between spatio-temporal observation data in a normal time and the spatio-temporal observation data input as a prediction target, the spatio-temporal observation data being spatio-temporal observation data with an attribute observed in advance and including an observation value as an element of an observation time and an observation location; a classification unit configured to classify the event components into events given in advance, based on the observation time, the observation location, the attribute, and the event component; and a prediction unit configured to predict variations in the spatio-temporal observation data for each of the events by using a model for predicting variations in the spatio-temporal observation data learned for the event, based on a classification result for the event, wherein the model is learned based on a classification result for each of the events obtained through classification of the event component into events given in advance based on the observation time, the observation location, the attribute, the event component for the spatio-temporal observation data for learning.

A third aspect of the present disclosure is a learning method for causing a computer to perform processing including: extracting event components, each of the event components representing a degree of variations between spatio-temporal observation data in a normal time and the spatio-temporal observation data during variations, the spatio-temporal observation data being spatio-temporal observation data with an attribute observed in advance and including an observation value as an element of an observation time and an observation location; classifying the event components into events given in advance, based on the observation time, the observation location, the attribute, and the event component; and learning a model for predicting variations in the spatio-temporal observation data for each of the events, based on a classification result for the event.

A fourth aspect of the present disclosure is a prediction method for causing a computer to perform processing including: extracting event components, each of the event components representing a degree of variations between spatio-temporal observation data in a normal time and the spatio-temporal observation data input as a prediction target, the spatio-temporal observation data being spatio-temporal observation data with an attribute observed in advance and including an observation value as an element of an observation time and an observation location; classifying the event components into events given in advance, based on the observation time, the observation location, the attribute, and the event component; and predicting variations in the spatio-temporal observation data for each of the events by using a model for predicting variations in the spatio-temporal observation data learned for the event, based on a classification result for the event, wherein the model is learned based on a classification result for each of the events obtained through classification of the event component into events given in advance based on the observation time, the observation location, the attribute, the event component for the spatio-temporal observation data for learning.

A fifth aspect of the present disclosure is a learning program for causing a computer to perform: extracting event components, each of the event components representing a degree of variations between spatio-temporal observation data in a normal time and the spatio-temporal observation data during variations, the spatio-temporal observation data being spatio-temporal observation data with an attribute observed in advance and including an observation value as an element of an observation time and an observation location; classifying the event components into events given in advance, based on the observation time, the observation location, the attribute, and the event component; and learning a model for predicting variations in the spatio-temporal observation data for each of the events, based on a classification result for the event.

A sixth aspect of the present disclosure is a prediction program for causing a computer to perform: extracting event components, each of the event components representing a degree of variations between spatio-temporal observation data in a normal time and the spatio-temporal observation data input as a prediction target, the spatio-temporal observation data being spatio-temporal observation data with an attribute observed in advance and including an observation value as an element of an observation time and an observation location; classifying the event components into events given in advance, based on the observation time, the observation location, the attribute, and the event component; and predicting variations in the spatio-temporal observation data for each of the events by using a model for predicting variations in the spatio-temporal observation data learned for the event, based on a classification result for the event, wherein the model is learned based on a classification result for each of the events obtained through classification of the event component into events given in advance based on the observation time, the observation location, the attribute, the event component for the spatio-temporal observation data for learning.

### Effects of the Invention

According to a disclosed technique, it is possible to perform prediction of spatio-temporal observation data in consideration of variations for each event, and to improve overall prediction accuracy.

### BRIEF DESCRIPTION OF DRAWINGS

FIG. 1 is a block diagram illustrating a configuration of a learning device according to the present embodiment.

FIG. 2 is a block diagram illustrating a hardware configuration of the learning device and a prediction device.

FIG. 3 is a diagram illustrating an example of spatio-temporal observation data.

FIG. 4 is a block diagram illustrating a configuration of the prediction device according to the present embodiment.

FIG. 5 is a flowchart illustrating a sequence of learning processing performed by the learning device.

FIG. 6 is a flowchart illustrating a sequence of prediction processing performed by the prediction device.

FIG. 7 is a flowchart illustrating a sequence of classification processing.

FIG. 8 is a diagram illustrating an example of an attribute tensor.

FIG. 9 is a diagram illustrating an example of a component matrix.

### Description of Embodiments

Hereinafter, one example of the embodiments of the disclosed technique will be described with reference to the drawings. In the drawings, the same reference numerals are given to the same or equivalent constituent elements and parts. Dimensional ratios in the drawings are exaggerated for the convenience of description and thus may be differ from actual ratios.

First, a summary of the technique of the present disclosure will be described. In the present embodiment, attribute information associated with spatio-temporal observation data is used to perform clustering of spatio-temporal observation data for each cluster strongly related to make a prediction of spatio-temporal observation data for each cluster. This prevents learning and prediction to take an incorrect correlation in reality and allows an accurate prediction at an occurrence of an event.

A configuration in the present embodiment will be described below. The present embodiment is based on a learning device and a prediction device. An input to each of the learning device and the prediction device is observed spatio-temporal observation data. An output of the learning device is a model that has been learned for each cluster. An output of the prediction device is a prediction value for each location at a prediction target time, and this does not include an attribute.

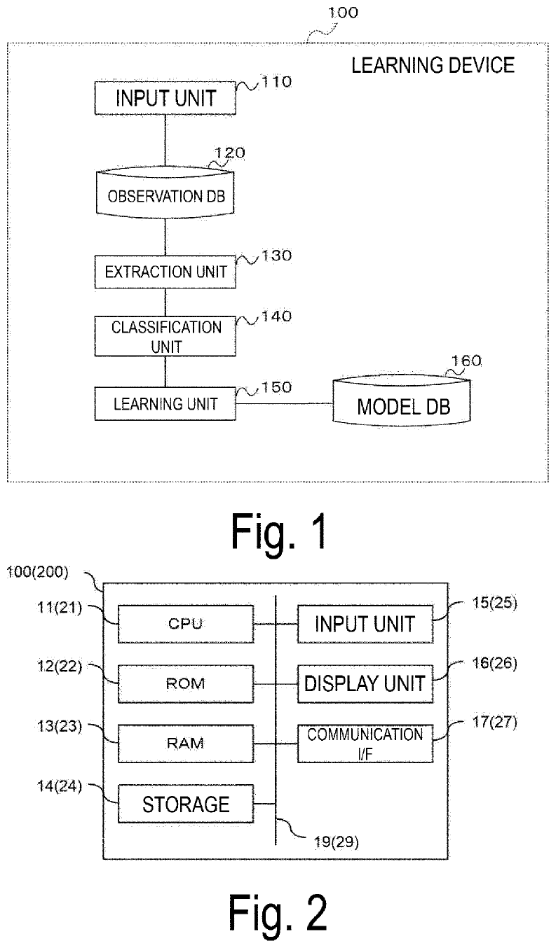

Learning Device
FIG. 1 is a block diagram illustrating a configuration of a learning device according to the present embodiment.

As illustrated in FIG. 1, the learning device 100 includes an input unit 110, an observation DB 120, an extraction unit 130, a classification unit 140, a learning unit 150, and a model DB 160.

FIG. 2 is a block diagram illustrating a hardware configuration of the learning device 100.

As illustrated in FIG. 2, the learning device 100 includes a central processing unit (CPU) 11, a read only memory (ROM) 12, a random access memory (RAM) 13, a storage 14, an input unit 15, a display unit 16, and a communication interface (I/F) 17. The components are communicatively interconnected through a bus 19.

The CPU 11 is a central processing unit that executes various programs and controls each unit. In other words, the CPU 11 reads a program from the ROM 12 or the storage 14 and executes the program using the RAM 13 as a work area. The CPU 11 performs control of each of the components described above and various arithmetic operation processes in accordance with a program stored in the ROM 12 or the storage 14. In the present embodiment, a learning program is stored in the ROM 12 or the storage 14.

The ROM 12 stores various programs and various kinds of data. The RAM 13 is a work area that temporarily stores a program or data. The storage 14 is constituted by a hard disk drive (HDD) or a solid state drive (SSD) and stores various programs including an operating system and various kinds of data.

The input unit 15 includes a pointing device such as a mouse and a keyboard and is used for performing various inputs.

The display unit 16 is, for example, a liquid crystal display and displays various kinds of information. The display unit 16 may employ a touch panel system and function as the input unit 15.

The communication interface 17 is an interface for communicating with other devices such as terminals and, for example, uses a standard such as Ethernet (registered trademark), FDDI, or Wi-Fi (registered trademark).

Next, each functional configuration of the learning device 100 will be described. Each functional component is realized by the CPU 11 reading a learning program stored in the ROM 12 or the storage 14, and expanding the learning program in the RAM 13 to execute the program.

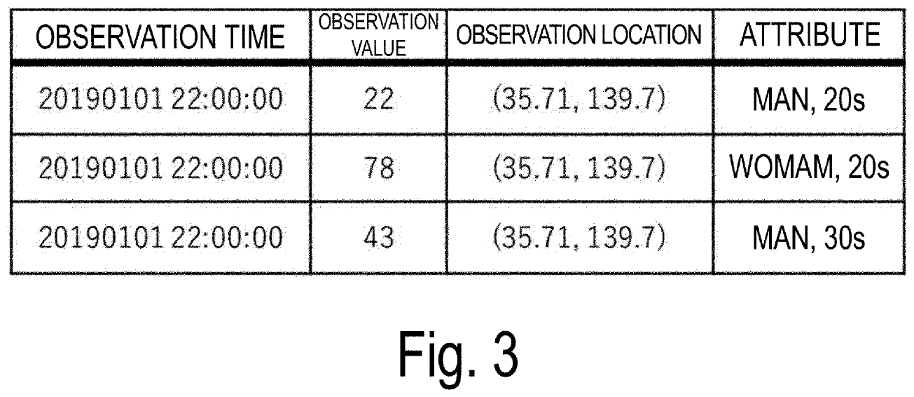

The input unit 110 receives spatio-temporal observation data in a normal time observed in advance and stores the data in the observation DB 120. FIG. 3 is a diagram illustrating an example of the spatio-temporal observation data. The spatio-temporal observation data stored in the observation DB 120 is attribute spatio-temporal observation data including observation values as elements of the observation times and observation locations, as illustrated in FIG. 3. The attribute is information representing an attribute of corresponding spatio-temporal observation data such as, for example, “male, 20s”, and the like. Here, the spatio-temporal observation data in a normal time refers to spatio-temporal observation data in which a periodic observation value is observed, and is spatio-temporal observation data in which no variation by an event has occurred. The input unit 110 receives spatio-temporal observation data during variations. The spatio-temporal observation data during variations is spatio-temporal observation data obtained when event-to-event variations occur.

The observation DB 120 is a database for storing the spatio-temporal observation data in a normal time and the spatio-temporal observation data during variations received by the input unit 110. As illustrated in FIG. 3, a set of an observation time, an observation value, an observation location, and an attribute is stored in the observation DB 120 for each record, and the set is handled as spatio-temporal observation data. It is only required that the spatio-temporal observation data in a normal time and the spatio-temporal observation data during variations be stored in separate tables. In the following, the processing is performed by using the spatio-temporal observation data stored in the observation DB 120.

The extraction unit 130 extracts an event component that represents the degree of variations between the spatio-temporal observation data in a normal time and the spatio-temporal observation data during variations. The extraction unit 130 compares the spatio-temporal observation data during variations and the spatio-temporal observation data in a normal time in the observation DB 120, and extracts an event component for a given time period τ. Here, the event component refers to a value indicating variations in the observation values, and is a difference of the observation values indicating the variation. For example, for the spatio-temporal observation data in a normal time, variations in the number of people in which the periodicity of time is strongly seen are stored in the observation DB 120 as an observation value. In this case, it is possible to perform estimation such as, for example, how many people of what kind of attribute can be observed at which location at 10 pm on Wednesday, from the periodicity of a normal time. The time period τ is taken as the time period from the current time to a past most recent time, as the time of variations corresponding to current and the normal time corresponding to past. For example, the time period τ is a time period from 9 pm to 10 pm on Wednesday. In other words, an estimated observation estimation value is determined by estimation using the average in the time periods or the like from observation values of observation time i and observation location j. The extraction unit 130 compares the estimated observation value during normal time and the estimated observation value during variations, and extracts an event component for learning by taking the difference. The event component is an element alternative to the observation value of spatio-temporal observation data with attributes of time period τ. The time period τ is set at a period of time sufficient for inputs of a prediction technique used for a model for prediction. In other words, the extraction unit 130 outputs, to the classification unit 140, each set of data of the observation time, observation location, attribute, and event component corresponding to spatio-temporal observation data of time period τ.

The classification unit 140 classifies the event components into events given in advance based on the sets of data of the observation time, observation location, attribute, and event component corresponding to the spatio-temporal observation data for time period τ. Here, based on the attributes of the sets of data, clustering of the event components to obtain clusters, each indicating independent events, is performed. The events here are such as different event sites, etc., as described above, and are independent events, without relevance. Various techniques can be used for the clustering here. As a simple method, clustering of the event components into different clusters for respective attributes may also be used. However, more generally, a technique is more desirable that can handle a case where a plurality of attributes are mixed in one event, or even a case where observations belonging to a plurality of different events are mixed in observation values at the same location and time of day. For example, a clustering technique by a topic model such as latent Dirichlet allocation (LDA), non-negative tensor factorization (NTF), or the like may be used. A detailed process flow for classification based on events by clustering will be described below in the description of effects.

Based on the classification results based on events, the learning unit 150 learns a model for predicting variations in spatio-temporal observation data for each event, and stores the learned model for each event in the model DB 160. Here, because each event corresponds to a cluster, the learning unit 150 learns the model for each cluster. The learning technique of a model may be used in any way as long as it is a technique that can learn a model. For example, the learning unit 150 uses any regression technique for spatio-temporal observation data such as an autoregressive model (AR), logistic regression, and the like. Various regression techniques for spatio-temporal observation data such as vector autoregressive model (VAR), state space model, Gaussian process regression, and recurrent neural network (RNN), or various prediction techniques based on spatio-temporal observation data, such as in PTL 1, may also be used.

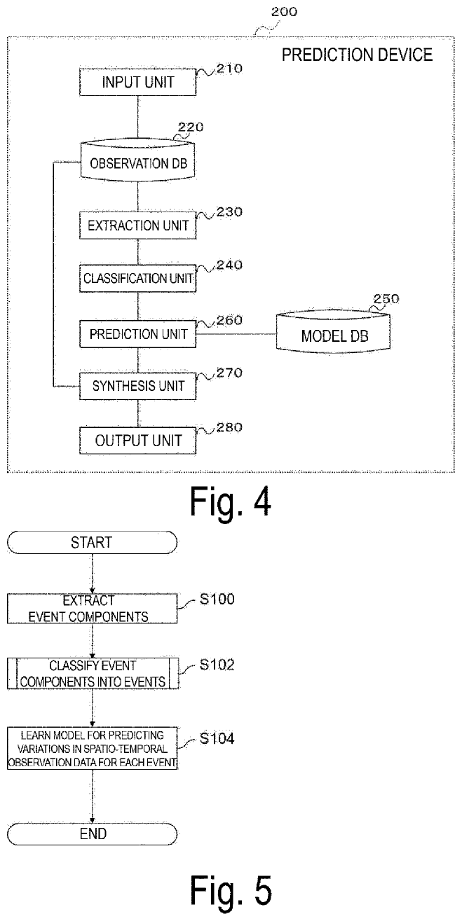

Configuration of Prediction Device
Next, a configuration of the prediction device will be described. FIG. 4 is a block diagram illustrating a configuration of the prediction device according to the present embodiment.

As illustrated in FIG. 4, the prediction device 200 includes an input unit 210, an observation DB 220, an extraction unit 230, a classification unit 240, a model DB 250, a prediction unit 260, a synthesis unit 270, and an output unit 280.

Note that the prediction device 200 can also be configured with a hardware configuration similar to that of the learning device 100. As illustrated in FIG. 2, the prediction device 200 includes a CPU 21, a ROM 22, a RAM 23, a storage 24, an input unit 25, a display unit 26, and a communication I/F 27. The components are communicatively interconnected through a bus 29. A prediction program is stored in the ROM 22 or the storage 24.

The input unit 210 receives the prediction target spatio-temporal observation data as an input and stores the data in the observation DB 220.

The observation DB 220 is a database for storing spatio-temporal observation data in a normal time observed in advance and prediction target spatio-temporal observation data. The spatio-temporal observation data in a normal time is stored in the observation DB 220 in advance. The spatio-temporal observation data in a normal time and the prediction target spatio-temporal observation data may be stored in separate tables.

The extraction unit 230 extracts an event component that represents the degree of variations between the spatio-temporal observation data in a normal time and the prediction target spatio-temporal observation data. The technique for extracting the event component is the same as the technique described for the extraction unit 130 of the learning device 100. The extraction unit 130 outputs, to the classification unit 240, each set of data of an observation time, observation location, attribute, and event component corresponding to spatio-temporal observation data of time period τ.

The classification unit 240 classifies event components into each event given in advance based on each set of data of observation times, observation locations, attributes, and event components corresponding to the spatio-temporal observation data for time period τ. The clustering technique for classifying event components is the same as the technique described in the classification unit 140 of the learning device 100.

The model DB 250 stores each model for predicting the variations of spatio-temporal observation data that has been learned for each event by the learning device 100.

Based on the classification results for the events, the prediction unit 260 uses a model learned for each event to predict variations in spatio-temporal observation data for the event. The prediction value output by the prediction unit 260 is a three-dimensional tensor having, for each cluster, each prediction value at the time i and the location j of a prediction target time t_{f} as elements. The time t_{f} is a time defined in a model predictable from the time period τ. The prediction unit 260 outputs a prediction value of each of the clusters for which prediction has been performed, to the synthesis unit 270.

The synthesis unit 270 adds together the prediction value for each of the clusters output by the prediction unit 260 and the observation estimation value in a normal time to synthesize a final prediction value. The observation estimation value in a normal time may be calculated for the prediction target time t_{f}, from the observation time i and the observation location j of the spatio-temporal observation data in the normal time of the observation DB 220. To use the prediction value for each of the clusters, a prediction result that reflects independent prediction value for each event is determined as a final prediction value.

The output unit 280 outputs the final prediction value synthesized by the synthesis unit 270 to the outside, and terminates the process.

Effects of Learning Device
Next, effects of the learning device 100 will be described.

FIG. 5 is a flowchart illustrating a sequence of the learning processing performed by the learning device 100. The CPU 11 reads the learning program from the ROM 12 or the storage 14, expands the learning program into the RAM 13, and executes the learning program, whereby the learning processing is performed. As an input, the learning device 100 receives the spatio-temporal observation data in a normal time observed in advance and the spatio-temporal observation data during variations, stores the data in the observation DB 120, and performs the following processes.

In step S100, the CPU 11 extracts an event component that represents the degree of variations between the spatio-temporal observation data in a normal time and the spatio-temporal observation data during variations.

At step S102, the CPU 11 classifies event components into the events given in advance based on each set of data of an observation time, observation location, attribute, and event component corresponding to the spatio-temporal observation data for the time period τ. Note that a detailed process flow of the classification will be described later.

At step S104, based on the classification results for each event, the CPU 11 learns a model for predicting the variations in spatio-temporal observation data for each event, and stores the learned model for each event in the model DB 160.

As described above, according to the learning device 100 of the present embodiment, a model for predicting spatio-temporal observation data in consideration of variations for each event can be learned.

Effects of Prediction Device
Next, effects of the prediction device 200 will be described.

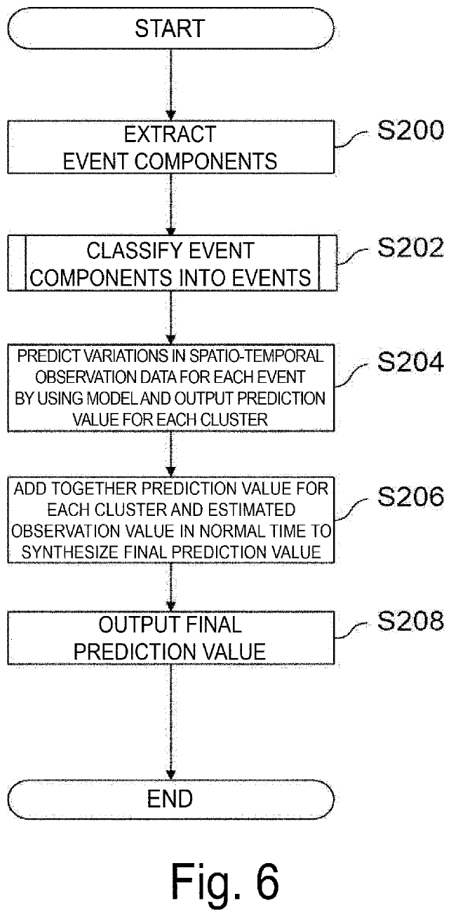

FIG. 6 is a flowchart illustrating a sequence of the prediction processing performed by the prediction device 200. The CPU 21 reads the prediction program from the ROM 22 or the storage 24, expands the prediction program into the RAM 23, and executes the prediction program, whereby the prediction processing is performed. As an input, the prediction device 200 receives the prediction target spatio-temporal observation data and stores the data in the observation DB 220, and performs the following processes.

In step S200, the CPU 21 extracts an event component that represents the degree of variations between the spatio-temporal observation data in a normal time and the spatio-temporal observation data to be predicted.

At step S202, the CPU 21 classifies event components into the events given in advance based on each set of data of an observation time, observation location, attribute, and event component corresponding to the spatio-temporal observation data for the time period τ. Note that a detailed process flow of the classification will be described later.

At step S204, based on the classification result for each event, the CPU 21 uses a model learned for the event to predict variations in spatio-temporal observation data for the event. In other words, the prediction value for each cluster is output.

In step S206, the CPU 21 adds together the prediction value for each of the clusters output at step S204 and the observation estimation value in a normal time to synthesize a final prediction value.

In step S208, the CPU 21 outputs the final prediction value synthesized in step S206 to the outside, and terminates the process.

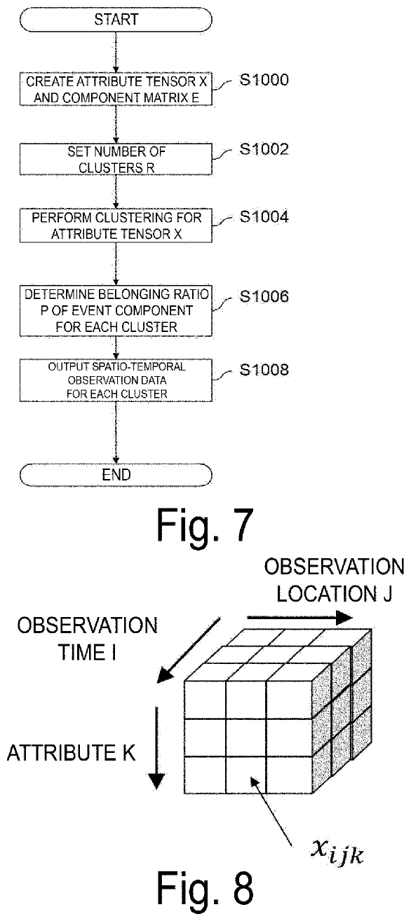

Next, details of processing as the classification unit 140 or the classification unit 240 according to the classifications of above steps S102 and S202 will be described. FIG. 7 is a flowchart illustrating a sequence of the classification processing. An example of a case of processing as the classification unit 240 of the prediction device 200 is described below, but this similarly applies to the classification unit 140 of the learning device 100, and the CPU 11 may perform the processing of each of the steps.

In step 1000, the CPU 21 creates an attribute tensor and a component matrix from each of the sets of data of an observation time, observation location, attribute, and event component corresponding to the spatio-temporal observation data for the time period τ. The attribute tensor is, so to speak, a time space attribute tensor. The component matrix is, so to speak, a time space event component matrix. The attribute tensor consists of three dimensions: observation time I, observation location J, and attribute K, represented below, where each element xi* of the attribute tensor is an absolute value of the event component. Hereinafter, x is also referred to as an event component for convenience of the description.

X=[xᵢⱼₖ]∈ [symbol] ₊^{I×J×K}

The attribute tensor is used as the input of the clustering. FIG. 8 is a diagram illustrating an example of the attribute tensor.

The component matrix is a matrix consisting of the observation time I and the observation location J, and each element eᵢⱼ of the matrix is a value obtained by adding together the event components of all the attributes at the time i and the location j.

E=[eᵢⱼ]∈ [symbol] ^{I×J}

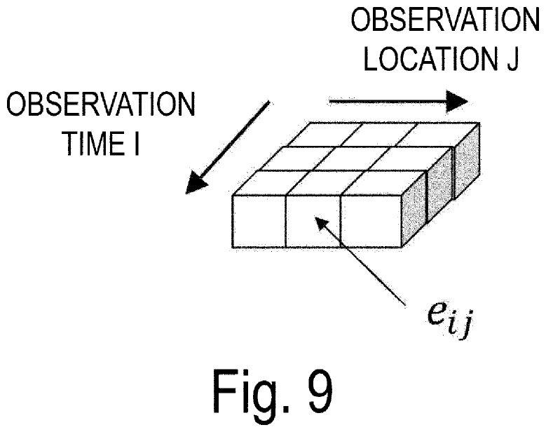

The component matrix is spatio-temporal observation data for each of the clusters that are multiplied by the belonging ratio of each of the clusters output as the result of the clustering. The spatio-temporal observation data for each cluster is used in the next process to generate an estimation value for each cluster. FIG. 9 is a diagram illustrating an example of the component matrix.

As described above, in step S1000, the CPU 21 creates the attribute tensor X, which is a tensor where the observation time I, observation location J, and attribute K are defined as dimensions and each element is defined as the event component x. In step S1000, the CPU 21 creates a component matrix E with the observation time I and observation location J as a matrix and the total value of the event components of all the attributes as elements.

In step S1002, the CPU 21 sets the number of clusters R generated by the clustering. The appropriate number of clusters is the number of events that make up the data of the target event components. In a case where the number of events is known in advance, the CPU 21 may set the value to the number of clusters R, and in a case where the number of events is not known, the CPU 21 may determine the number of clusters R from the trend of the past data, to define the value.

In step S1004, the CPU 21 performs clustering by using the NTF for the attribute tensor X. In this case, the CPU 21 performs tensor decomposition on the three-dimensional attribute tensor X as the internal product of the following three matrices A, B, and C, where the number of ranks corresponds to the number of clusters R.

A=[aᵢᵣ]∈ [symbol] ₊^{I×R},

B=[bⱼᵣ]∈ [symbol] ₊^{J×R},

C=[cₖᵣ]∈ [symbol] ₊^{J×R}

In tensor decomposition, the CPU 21 performs the decomposition so that the internal product ^X=[^xᵢⱼₖ] of the matrices A, B, and C after decomposition (^ is attached on top of the subsequent symbol in mathematical formula, and this similarly applies below) reproduces the original tensor X=[xᵢⱼₖ]. Specifically, matrices A, B, and C are determined to minimize the objective function according to Equation (1) below.

$$\begin{matrix}[ Math . 1 ] & \\ \begin{matrix}OBJECTIVE \\ FUNCTION\end{matrix} = {\sum }_{i}^{I} {\sum }_{j}^{J} {\sum }_{k}^{K} d ( {x}_{ijk} , {\hat{x}}_{ijk} ) & ( 1 )\end{matrix}$$

Here, dd (·,·) represents a distance function, and a KL divergence or Euclidean distance is used. In this manner, in step S1004, the CPU 21 performs clustering by performing tensor decomposition on the attribute tensor with the events as clusters such that the attribute tensor is an internal product of the matrix A represented by the observation time I, the matrix B represented by the observation location J, and the matrix C represented by the attribute K for each cluster. In this way, the event component ^xᵢⱼₖ for each cluster is determined from the matrices A, B, and C.

In step S1006, the CPU 21 uses the matrices A, B, and C obtained by tensor decomposition to determine a belonging ratio P of an event component x for each cluster. Hereinafter, the sequence of the process for determining the belonging ratio P will be described. First, the event component ^xᵢⱼₖ is represented by Equation (2) below.

$$\begin{matrix}[ Math . 2 ] & \\ {\hat{x}}_{ijk} = {{\sum }_{r}}^{R} {a}_{ir} {b}_{jr} {c}_{kr} & ( 2 )\end{matrix}$$

Because the information of the attributes used for clustering is not used in the process for determining a prediction value, the CPU 21 adds up the event components for each attribute of the attribute tensor of each rank to delete attribute column as in Equation (3) below.

$$\begin{matrix}[ Math . 3 ] & \\ {\hat{x}}_{ij} = {\sum }_{k}^{K} {\hat{x}}_{ijk} & ( 3 )\end{matrix}$$

In addition, the event component ^xᵢⱼᵣ is divided by the sum of the clusters r, as described in Equation (4) below, and converted to the ratio for the cluster r.

$$\begin{matrix}[ Math . 4 ] & \\ {p}_{ijr} = \{ \begin{matrix}0 & ( {{\sum }_{r}}^{R} {\hat{x}}_{ijk} = 0 ) \\ \frac{{\hat{x}}_{ijk}}{{\sum }_{r}^{R} {\hat{x}}_{ijk}} & ( otherwise )\end{matrix} & ( 4 )\end{matrix}$$

Pᵣ=[pᵢⱼᵣ] generated in this way represents the belonging ratio of the cluster r of the event component ^xᵢⱼᵣ, while at the same time representing the ratio at which the spatio-temporal observation data belongs to the cluster r.

As described above, in step S1006, the CPU 21 determines, for each cluster, the belonging ratio that indicates the ratio at which an event component belongs to the cluster.

In step S1008, the CPU 21 generates and outputs spatio-temporal observation data for each cluster based on the belonging ratio Pᵣ for each cluster and the component matrix E. The spatio-temporal observation data for each cluster is passed to a process for determining the prediction value as a classification result for each event, i.e., step S104 or step S204. The CPU 21 takes an internal product of the component matrix E generated in step S1000 and the belonging ratio Pᵣ for each cluster, as described in Equation (5) below, to generate and output spatio-temporal observation data Sᵣ for each cluster. The spatio-temporal observation data Sᵣ for each cluster is spatio-temporal observation data that includes the components of the cluster r as elements of the observation time and observation location.

[Math. 5]

Sᵣ=E⊗Pᵣ (5)

The components of the cluster r are each a component obtained as a result by taking an internal product of the component matrix E and the belonging ratio Pᵣ for each cluster, and is a component that reflects the degree of variations represented by the component matrix E and the ratio of the event component in the cluster represented by the belonging ratio Pᵣ. As described above, in step S1008, the CPU 21 outputs the spatio-temporal observation data for each cluster obtained by determining the internal product of the belonging ratio for each cluster and the component matrix as a classification result for each event. In step S204 described above, prediction is performed by using the spatio-temporal observation data for each cluster obtained in this manner as an input of a model for each cluster, so the output of an appropriate prediction value for each cluster is possible. Similarly, in step S104 described above, learning is performed by using the spatio-temporal observation data for each cluster obtained in this manner as an input of learning a model for each cluster, so a model capable of outputting an appropriate prediction value for each cluster can be learned.

As described above, according to the prediction device 200 of the present embodiment, it is possible to perform prediction of spatio-temporal observation data in consideration of variations for each event, and overall prediction accuracy can be improved.

Note that, in each of the above-described embodiments, various processors other than the CPU may execute the learning processing or the prediction processing which the CPU executes by reading software (program). Examples of the processor in such a case include a programmable logic device (PLD) such as a field-programmable gate array (FPGA) of which circuit configuration can be changed after manufacturing, a dedicated electric circuit such as an application specific integrated circuit (ASIC) that is a processor having a circuit configuration designed dedicatedly for executing a specific process, and the like. The learning processing or the prediction processing may be executed by one of such various processors or may be executed by a combination of two or more processors of the same type or different types (for example, a plurality of FPGAs, a combination of a CPU and an FPGA, or the like). More specifically, the hardware structure of such various processors is an electrical circuit acquired by combining circuit devices such as semiconductor devices.

In the embodiment described above, an aspect has been described in which the learning program is stored (installed) in advance in the storage 14, but the present disclosure is not limited thereto. The program may be provided in the form of being stored in a non-transitory storage medium such as a compact disk read only memory (CD-ROM), a digital versatile disk read only memory (DVD-RAM), or a universal serial bus (USB) memory. The program may be in a form that is downloaded from an external device via a network.

With respect to the above embodiment, the following supplements are further disclosed.

Supplementary Note 1
A learning device including:
a memory; and
at least one processor connected to the memory,
wherein the processor is configured to:
extract event components, each of the event components representing a degree of variations between spatio-temporal observation data in a normal time and the spatio-temporal observation data during variations, the spatio-temporal observation data being spatio-temporal observation data with an attribute observed in advance and including an observation value as an element of an observation time and an observation location;
classify the event components into events given in advance, based on the observation time, the observation location, the attribute, and the event component; and
learn a model for predicting variations in the spatio-temporal observation data for each of the events, based on a classification result for the event.

Supplementary Note 2
A non-transitory storage medium storing a learning program for causing a computer to perform: extracting event components, each of the event components representing a degree of variations between spatio-temporal observation data in a normal time and the spatio-temporal observation data during variations, the spatio-temporal observation data being spatio-temporal observation data with an attribute observed in advance and including an observation value as an element of an observation time and an observation location;
classifying the event components into events given in advance, based on the observation time, the observation location, the attribute, and the event component; and
learning a model for predicting variations in the spatio-temporal observation data for each of the events, based on a classification result for the event.

### REFERENCE SIGNS LIST

100 Learning device
110 Input unit
120 Observation DB
130 Extraction unit
140 Classification unit
150 Learning unit
160 Model DB
200 Prediction device
210 Input unit
220 Observation DB
230 Extraction unit
240 Classification unit
250 Model DB
260 Prediction unit
270 Synthesis unit
280 Output unit

1. A learning device comprising circuitry configured to execute a method comprising:
extracting event components, each of the event components representing a degree of variations between spatio-temporal observation data in a normal time and the spatio-temporal observation data during variations, the spatio-temporal observation data being spatio-temporal observation data with an attribute observed in advance and including an observation value as an element of an observation time and an observation location;
classifying the event components into events given in advance, based on the observation time, the observation location, the attribute, and the event component; and
learning a model for predicting variations in the spatio-temporal observation data for each of the events, based on a classification result for the event.

2. The learning device according to claim 1, the circuitry further configured to execute a method comprising:
creating, using each of the event components as a difference in the observation value indicating the variations, an attribute tensor and a component matrix, the attribute tensor being a tensor with the observation time, the observation location, and the attribute as dimensions and each element as the event component, the component matrix being with the observation location and the observation time as matrices and a total value of the event components of all attributes as an element;
performing, by using the events as clusters, perform tensor decomposition such that the attribute tensor is an internal product of a matrix represented by the observation time, a matrix represented by the observation location, and a matrix represented by the attribute for each of the clusters;
determining the event component for each of the clusters from each matrix obtained by the tensor decomposition;
determining, for each of the clusters, a belonging ratio that indicates a ratio of the event component belonging to the cluster; and
generating, for each of the clusters, spatio-temporal observation data including components of the cluster as elements of the observation time and the observation location obtained by determining an internal product of the belonging ratio for the cluster and the component matrix, as a classification result for the event.

3. A prediction device comprising circuitry configured to execute a method comprising:
extracting event components, each of the event components representing a degree of variations between spatio-temporal observation data in a normal time and the spatio-temporal observation data input as a prediction target, the spatio-temporal observation data being spatio-temporal observation data with an attribute observed in advance and including an observation value as an element of an observation time and an observation location;
classifying the event components into events given in advance, based on the observation time, the observation location, the attribute, and the event component; and
predicting variations in the spatio-temporal observation data for each of the events by using a model for predicting variations in the spatio-temporal observation data learned for the event, based on a classification result for the event,
wherein the model is learned based on a classification result for each of the events obtained through classification of the event component into events given in advance based on the observation time, the observation location, the attribute, the event component for the spatio-temporal observation data for learning.

4. A computer-implemented method for learning a model, comprising:
extracting event components, each of the event components representing a degree of variations between spatio-temporal observation data in a normal time and the spatio-temporal observation data during variations, the spatio-temporal observation data being spatio-temporal observation data with an attribute observed in advance and including an observation value as an element of an observation time and an observation location;
classifying the event components into events given in advance, based on the observation time, the observation location, the attribute, and the event component; and
learning a model for predicting variations in the spatio-temporal observation data for each of the events, based on a classification result for the event.

5. The computer-implemented method according to claim 4,
creating, using each of the event components as a difference in the observation value indicting the valuations, an attribute tensor and a component matrix, the attribute tensor being a tensor with the observation time, the observation location, and the attribute as dimensions and each element as the event component, the component matrix being with the observation location and the observation time as matrices and a total value of the event components of all attributes as an element;
performing, by using the events as clusters, tensor decomposition such that the attribute tensor is an internal product of a matrix represented by the observation time, a matrix represented by the observation location, and a matrix represented by the attribute for each of the clusters;
determining the event component for each of the clusters from each matrix obtained by the tensor decomposition;
determining, for each of the clusters, a belonging ratio indicating a ratio of the event component belonging to the cluster; and
generating, for each of the clusters, spatio-temporal observation data as a classification result for the event, the spatio-temporal observation data including components of the cluster as elements of the observation time and the observation location obtained by determining an internal product of the belonging ratio for the cluster and the component matrix.

6-8. (canceled)

9. The learning device according to claim 1, wherein
the spatio-temporal observation data includes at least an observation time, an observation location, an observation value, and an attribute associated with the observation value.

10. The prediction device according to claim 3, wherein
the spatio-temporal observation data includes at least an observation time, an observation location, an observation value, and an attribute associated with the observation value.

11. A computer-implemented method according to claim 4, wherein
the spatio-temporal observation data includes at least an observation time, an observation location, an observation value, and an attribute associated with the observation value.

12. The learning device according to claim 9, wherein the observation value includes a number of people.

13. The prediction device according to claim 10, wherein the observation value includes a number of people.

14. The computer-implemented method according to claim 11, wherein the observation value includes a number of people.
